(19) United States
(12) Patent Application Publication
(10) Pub. No.: US 2008/0278050 A1
(43) Pub. Date: Nov. 13, 2008

(54) Electric Lamp and Method For Mounting a Lamp Vessel in an Outer Bulb

(75) Inventor: Leonardus Gerardus Maria Michiels, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,910

(22) PCT Filed: Jun. 27, 2005
(86) PCT No.: PCT/IB2005/052120

§ 371 Date: Dec. 19, 2006

(30) Foreign Application Priority Data
Jun. 29, 2004 (EP) 04103024.8

(51) Int. Cl. H01J 61/34; H01J 9/02

(52) U.S. Cl. 313/25; 445/23

(57) ABSTRACT

An electric lamp comprising a substantially tubular lamp vessel, which is enclosed in a substantially tubular outer bulb, wherein the lamp vessel has current conductors extending from respective ends of the lamp vessel for providing current to an electric element inside the lamp vessel, wherein the current conductors are mounted in the outer bulb such that the lamp vessel is axially aligned in the outer bulb, and wherein at least one current conductor is mounted in the outer bulb by means of a support member comprising an at least partly circular outer support edge having an outer diameter which is substantially equal to the inner diameter of the outer bulb, characterized in that the support member comprises a substantially radially extending fixation edge on which the current conductor is fixedly mounted.

The invention relates to an electric lamp comprising a substantially tubular lamp vessel which is enclosed in a substantially tubular outer bulb, wherein the lamp vessel has current conductors extending from respective ends of the lamp vessel for providing current to an electric element inside the lamp vessel, wherein the current conductors are mounted in the outer bulb such that the lamp vessel is axially aligned in the outer bulb, and wherein at least one current conductor is mounted in the outer bulb by means of a support member comprising an at least partly circular outer support edge having an outer diameter which is substantially equal to the inner diameter of the outer bulb.

Such a lamp is disclosed in GB 1 330 958. The support member in the lamp consists of a spiral-shaped centering member and is formed by part of the molybdenum current conductor wire. The lamp in this case is a high-pressure sodium vapor lamp lamp.

Where electric lamps, such as automotive (gas discharge) lamps or halogen projection lamps, are becoming smaller, centering of the lamp vessel or burner in the outer bulb by means of a spiral-shaped or spring member is not very accurate. Furthermore, the shape of the burner is not always exactly the same, which may cause deviations in the alignment of the lamp vessel. The object of the invention is a lamp wherein the alignment is more accurate and can be easily adapted to the irregular shape of the lamp vessel.

According to the invention, the support member comprises a substantially radially extending fixation edge on which the current conductor is fixedly mounted. The edge preferably extends along a substantial portion of the diameter of the outer bulb, preferably more than 50% thereof. The radial position of the fixation of the current conductor to the support member can be very accurately achieved thereby, and irregularities in shape can be readily compensated for.

In a preferred embodiment, a substantially tubular bush forms said outer support edge. Said bush is preferably open at one end and substantially closed at the other end by means of an end wall, and said radially extending fixation edge is formed by a slot in said end wall. In a preferred embodiment, the open end of the bush surrounds the end of the lamp vessel or burner, so that a very compact arrangement is achieved, wherein the end wall of the bush extends just past the end of the burner.

The width of the slot is preferably substantially equal to the diameter of the current conductor, such that the current conductor can be securely fixed to both sides of the slot. The material of the support member is preferably substantially the same as the material of the current conductor, for instance niobium, so that the current conductor can be welded to the fixation edge of the support member, preferably by means of laser welding.

The invention further relates to a method of mounting a substantially tubular lamp vessel of an electric lamp in a substantially tubular outer bulb, wherein the lamp vessel has current conductors extending from respective ends of the lamp vessel for providing current to the electric element inside the lamp vessel, wherein the current conductors are mounted in the outer bulb such that the lamp vessel is axially aligned in the outer bulb, and wherein at least one current conductor is mounted in the outer bulb by means of a support member comprising an at least partly circular outer support edge having an outer diameter which is substantially equal to the inner diameter of the outer bulb, characterized in that the current conductor is fixedly mounted on a substantially radially extending fixation edge of the support member.

The above and further aspects of the lamp according to the invention will now be explained with reference to a drawing (not true to scale), in which:

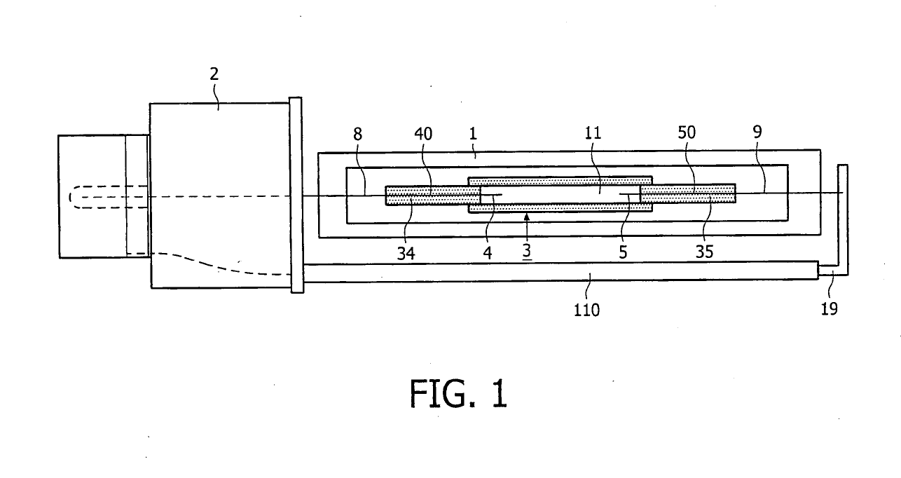

FIG. 1 diagrammatically shows a lamp comprising a lamp vessel and an outer bulb;

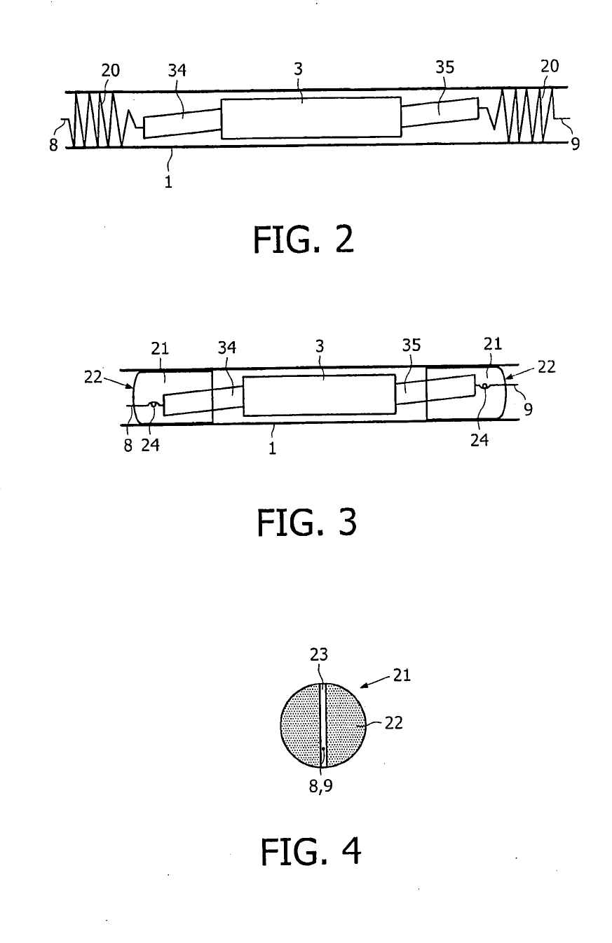

FIG. 2 schematically shows the prior art alignment of the lamp vessel and the outer bulb of FIG. 1;

FIG. 3 schematically shows the alignment according to the invention of the lamp vessel and the outer bulb of FIG. 1; and

FIG. 4 shows the end wall of the support member according to the invention, wherein the current conductor is mounted.

FIG. 1 shows a metal halide lamp provided with a lamp vessel 3. The lamp vessel has a ceramic wall which encloses a lamp space 11 containing Xe and an ionizable filling with NaI and CeI₃. Two electrodes 4, 5 as the electric element are arranged in the lamp vessel.

The discharge vessel is closed off at either end by a respective ceramic projecting plug 34, 35 which encloses with narrow interspacing a respective current lead-through conductor 40, 50 to the electrodes 4, 5 arranged in the lamp vessel. Alternatively, the electric element might be a tungsten filament in which case the electric lamp is an (halogen) incandescent lamp. The lamp vessel is surrounded by an outer bulb 1. The lamp is further provided with a lamp cap 2. A lamp is generated between the electrodes 4 and 5 in the operational state of the lamp. The electrode 4 is connected to a first electrical contact forming part of the lamp cap 2 via a current conductor 8. The electrode 5 is connected to a second electrical contact forming part of the lamp cap 2 via current conductors 9 and 19. The current conductor 19 is surrounded by a ceramic tube 110.

In a practical realization of a lamp according to the invention as represented in the drawing, a number of lamps were manufactured with a rated power of 26 W each. The lamps are suitable for use as headlamps in a motor vehicle. The ionizable filling of the lamp vessel of each individual lamp comprises 0.35 mg Hg and 0.7 mg NaCe iodide in a molar percentage of 85.7 Na and 14.3 Ce (molar ratio 6:1). The filling further comprises Xe with a filling pressure at room temperature of 7 bar.

The distance between the tips of the electrodes 4, 5 is 5 mm, the internal diameter of the lamp vessel is 1.4 mm. The wall thickness of the lamp vessel is 0.3 mm. The outer bulb 1 of the lamp is made of quartz glass. The internal diameter of the outer bulb is 3 mm, its wall thickness is 2 mm. The outer bulb is filled with N₂ with a filling pressure of 1.5 bar.

FIG. 2 shows a prior art support member 20 for aligning the lamp vessel 3 in the outer bulb 1. The end plugs 34, 35 are drawn not in line with the axis of the lamp vessel 3, which in practice may indeed be the case. The support member 20 consists of a spring- or spiral-shaped part of the niobium current conductors 8, 9, the outer diameter of which is substantially equal to the inner diameter of the outer bulb 1. The spring or spiral member 20 also provides compensation for expansion of the burner due to temperature changes. It will be appreciated that the alignment between the lamp vessel 3 and the outer bulb 1 is difficult to achieve with such support members 20 that are part of the current conductors 8, 9, in particular if each end plug 34, 35 extends from the lamp vessel 3 at a slightly different angle.

According to FIGS. 3 and 4, the support member 21 consists of a niobium tubular part having an end wall 22 at one side. The end wall 22 is provided with a slot 23 across its entire diameter. Said diameter is substantially the same as the internal diameter of the outer bulb 1, so that the support member 21 tightly fits in said outer bulb 1. The width of the slot 23 is substantially the same as the diameter of the current conductor 8, 9. When the lamp vessel 3 is mounted in the outer bulb 1, the support members 21 can be rotated in the outer bulb 1 and the current conductors 8, 9 can be moved in the slot 23 so as to perfectly align the lamp vessel 3 in the outer bulb 1. Once this perfect alignment is achieved, the current conductor 8, 9 is fixed to both edges of the slot 23 by laser welding.

Each support member 21 is arranged such that the open end opposite the end wall 22 surrounds the end plugs 34, 35. The end wall 22 thus extends just past the ends of the end plugs 34, 35, only enclosing a small spring-shaped part 24 of the current conductor. Said spring-shaped part 24 is necessary to compensate for expansion due to temperature changes. In this manner a very compact lamp can be achieved compared with the embodiment of FIG. 2.

The scope of the invention is not limited to the above embodiments. The invention is embodied in each new characteristic and each combination of characteristics. Any reference sign does not limit the scope of the claims. The word “comprising” does not exclude the presence of other elements or steps than those listed in a claim. Use of the word “a” or “an” preceding an element does not exclude the presence of a plurality of such elements.

1. An electric lamp comprising a substantially tubular lamp vessel, which is enclosed in a substantially tubular outer bulb, wherein the lamp vessel has current conductors extending from respective ends of the lamp vessel for providing current to an electric element inside the lamp vessel, wherein the current conductors are mounted in the outer bulb such that the lamp vessel is axially aligned in the outer bulb, and wherein at least one current conductor is mounted in the outer bulb by means of a support member comprising an at least partly circular outer support edge having an outer diameter which is substantially equal to the inner diameter of the outer bulb, characterized in that the support member comprises a substantially radially extending fixation edge on which the current conductor is fixedly mounted.

2. The electric lamp according to claim 1, wherein end plugs extend from respective ends of the lamp vessel, the current conductors extending from said end plugs.

3. The electric lamp according to claim 1, wherein a substantially tubular bush forms said outer support edge.

4. The electric lamp according to claim 3, wherein said bush is open at one end and substantially closed at the other end by means of an end wall, and said radially extending fixation edge is formed by a slot in said end wall.

5. The electric lamp according to claim 4, wherein the width of said slot is substantially equal to the diameter of the current conductor.

6. The electric lamp according to claim 1, wherein the material of the support member is substantially the same as the material of the current conductor, for example niobium.

7. The electric lamp according to claim 1, wherein the current conductor is welded to the fixation edge of the support member.

8. The electric lamp according to claim 1, wherein the current conductor comprises a spring extending between the lamp vessel and the fixation edge.

9. The electric lamp according to claim 1, wherein the electric lamp is a high primare gas discharge lamp.

10. Method of mounting a substantially tubular lamp vessel of a electric lamp in a substantially tubular outer bulb, wherein the lamp vessel has current conductors extending from respective ends of the lamp vessel for providing current to an electric element inside the lamp vessel, wherein the current conductors are mounted in the outer bulb such that the lamp vessel is axially aligned in the outer bulb, and wherein at least one current conductor is mounted in the outer bulb by means of a support member comprising an at least partly circular outer support edge having an outer diameter which is substantially equal to the inner diameter of the outer bulb, characterized in that the current conductor is fixedly mounted on a substantially radially extending fixation edge of the support member.

11. Method according to claim 10, wherein the current conductor is welded to the fixation edge of the support member by means of a laser.
